(19) United States
(12) Patent Application Publication
(10) Pub. No.: US 2007/0259211 A1
(43) Pub. Date: Nov. 8, 2007

(54) Heat spread sheet with anisotropic thermal conductivity

(76) Inventor: Ning Wang, Martinez, CA (US)

Correspondence Address: Ning Wang, 47 Fountainhead Ct, Martinez, CA, 94553, US

(21) Appl. No.: 11/796,430

(22) Filed: Apr. 28, 2007

Related U.S. Application Data
(60) Provisional application No. 60/798,057, filed on May 6, 2006.

(51) Int. Cl. B32B 9/00

(52) U.S. Cl. 428/698; 524/404

(57) ABSTRACT

This invention relates to a heat spread sheet material comprised of hexagonal boron nitride with adhesives. Extraction process for adhesive coating greatly decreases the adhesive fraction and provides an evenly distributed thin adhesive film on the surface of hexagonal boron nitride powders. This sheet material shows a layer structure and anisotropic properties. With 10 vol % (5.5 wt %) of phenolic epoxy, thermal conductivity along the base plane of the sheet reaches 48 W/m·K, and CTE reaches 3.5 ppm/K.

### CROSS-REFERENCE TO RELATED APPLICATION

This application claims the benefits of provisional patent application Ser. No. U.S. 60/798,057, filed May 6, 2006 by the present inventor.

### FIELD OF THE INVENTION

This invention relates to a heat spread sheet based on a boron nitride composition. It has different thermal conductivity in X-Y plan and along Z direction and a low coefficient of thermal expansion (CTE).

### BACKGROUND OF THE INVENTION

The dramatic increase in circuit density of electronic devices has lead to problems related to the dissipation of heat generated in such devices. Various devices, heat sinks and heat spreaders are used to assist in the dissipation of heat. For this purpose, different metals, ceramics and organic polymers are used for semiconductor packaging and other electric devices. The usage of each of these materials is limited by their properties, which can only partially fulfill all requirements on thermal conductivity, electric insulation, low CTE, low dielectric constant, etc. Composite materials provide a new choice to replace the simple materials. A composite of hexagonal boron nitride (hBN) with polymer is a promising material as heat spreader.

Hexagonal boron nitride is a relatively soft ceramic, which has a layer structure similar to graphite. The morphology of h-BN single crystal particle is show in FIG. 1 (GE, PT110). Though no accurate data of thermal properties of hBN were published, Richard Hill (J. Am. Ceram. Soc., 85 [4] 851-857, 2002) provided a set of thermal conductivity data: 400 W/m·K (along the base plane, the X-Y plane) and 2 W/m·K (perpendicular to the base plane, along the Z direction). This very high thermal conductivity in X-Y plan makes hBN promising for heat spreading application. Richard Hill also reported that deformation of h-BN platelet shaped particles makes compact density of hBN powders reaches to 92% of theoretical density. As a comparison, the maximum compact density of other ceramic powders is about 50% of theoretical density. The high compact density increases the contact area of adjacent hBN particles, which greatly decreases the thermal resistance between particles and greatly increases thermal conductivity in high density hBN composite materials.

When hBN fraction in the composite is less than 50%, the h-BN powders are fully separated by polymer. The thermal conductivity of polymer is smaller than 1 W/m·K, so that the thermal resistance between hBN particles is rather high. It was reported that 25.7 vol % hBN only exhibited a thermal conductivity of 1.08 W/m·K (Journal of Inorganic and organometallic Polymers and Materials, Vol. 16, No. 2, June 2006, 175-183). When hBN fraction in the composite increases, the thermal conductivity of the composite gradually increases. U.S. Pat. No. 5,681,883 reported a thermal conductivity of 12 W/m·K with a 70 wt % of hBN filler. U.S. Pat. No. 6,162,849 reported a thermal conductivity of 21 W/m·K with a 75 wt % of hBN filler (GE, PT 110). US published patent 2007/0041918 reported a thermal conductivity of 35 W/m·K with a 90 wt % of hBN filler.

On the other hand, the hBN fraction in the composite is also related to its CTE value. The CTE of hBN is 1 ppm/K or less. A typical CTE of polymer is about 15 ppm/K. The CTE of silicon wafer is 2.7 ppm/K. Therefore, the fraction of polymer in the composite should be greatly decreased to make CTE of the composite matching with that of silicon wafer. In present invention, a new method is suggested to make a new heat spreader with high hBN fraction.

### BRIEF SUMMARY OF THE INVENTION

In present invention, a small ratio of polymers, including thermoplastic and thermosetting polymers, is used as adhesive. Inorganic adhesives may also be used. These adhesives are coated on the surface of hBN particles. The coated particles are pressed in a mold into sheet, or form a sheet by rolling process. Different heating processed are followed with the forming process, according to different adhesives. During pressing process, hBN plate-shape particles are oriented to parallel to the sheet base plan. In this way, the sheets obtain a high compact density, an anisotropic structure and anisotropic properties. The schematic of the sheet structure is shown in FIG. 2.

The present invention further relates to an extraction method to make adhesive coating on the hBN surface. Extraction process makes a small ratio of adhesive evenly coated on hBN surface, which ensure the hBN sheets have enough strength and good thermal conductivity.

### BRIEF DESCRIPTION OF DRAWINGS

FIG. 1 SEM photo of hBN plate-shape particles, copied from the web site of GE advanced Ceramics.

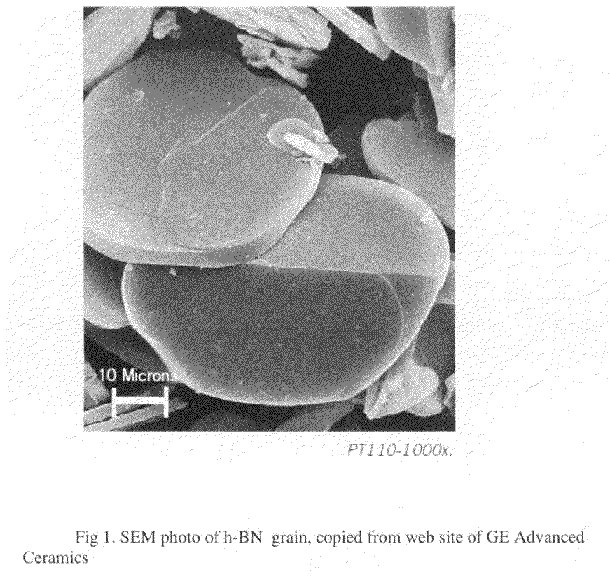

FIG. 2 Schematic of hBN sheet structure.

FIG. 3 SEM photo of agglomerated hBN granules with 10 vol % of epoxy.

### DETAILED DESCRIPTION OF THE INVENTION

In a hBN composite with polymer, an evenly distributed thin polymer film is a critical problem to decrease ratio of polymer. Some traditional mixing process, such as mechanically milling process, can not provide an evenly distributed polymer film, so that the polymer ratio is rather high. In wet process, spraying dry is an alternative method to make polymer coating. Spraying dry process heats the mixed droplets of polymer solution containing hBN powders. After removing solvent, polymer is coated on the powder surface. In this way, it is difficult to control the ratio of solution and solid powders in different droplets, so that the polymer is not evenly coated on different hBN powders.

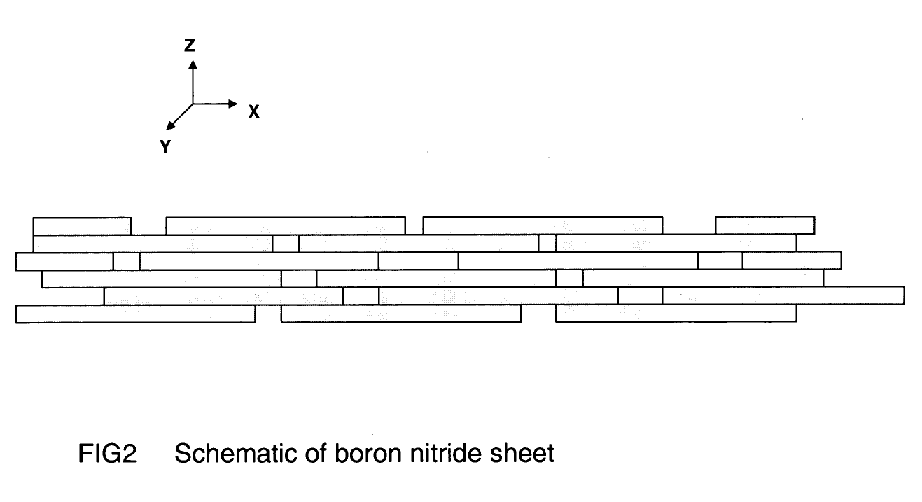

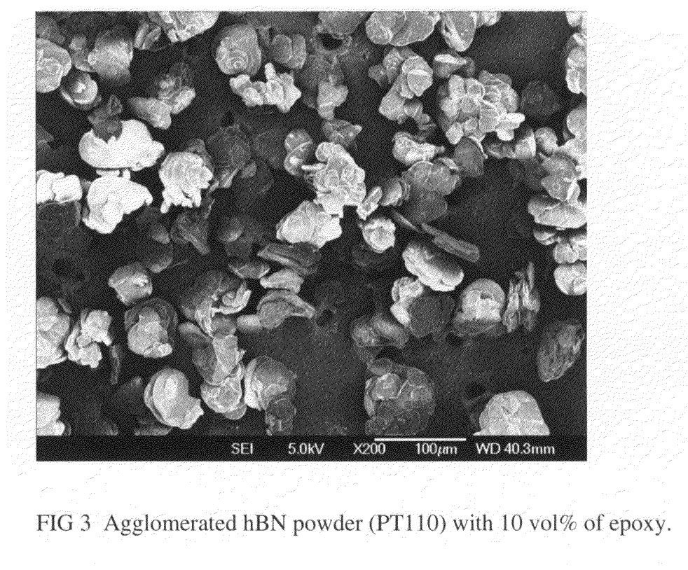

In present invention, extraction method is used to make an even distributed adhesive film on hBN powders. In the case of organic polymer, a certain polymer is dissolved in a certain organic solvent. For example, epoxy may be dissolved in acetone. A certain amount of hBN powder is added in this solution. A stirring device is used to make hBN powders evenly suspended in the solution. Then, pure water is gradually added into the solution. As the water ratio in the solution increases, the solubility of epoxy decreases and gradually deposits on the hBN surface. Finally, almost all epoxy is coated on the hBN surface. This is a slow and controllable process. The coating is much more evenly distributed on all hBN powders. After extraction process the coated hBN powders are sieved and dried to remove water and acetone. FIG. 3 shows a SEM photo of the coated hBN powders with 10 vol % of phenolic epoxy. The powders are slightly agglomerated into granules with a flat shape. The size of the granules is about 40-60 μm. The aspect ratio of the granules is about 3-5. In each of granule, several hBN powders parallelly overlap together, which provides a very high primary packing density of hBN powders. In following forming process, these flat granules are easily parallelly oriented, which ensure high packing density and anisotropic structure of the hBN sheets as shown in FIG. 2.

In present invention, mold-pressing process and rolling process are used as forming process of the h-BN sheets. With organic adhesives, the mold is heated to a temperature, at which the adhesives are softened or melted. During pressing process, the melted polymer plays a role of lubricant, which helps hBN particles parallelly oriented. Rolling process exerts a shear force on the green body of hBN sheet, which makes hBN particles more easily to be parallelly oriented.

For organic adhesives, thermoplastic polymer and thermosetting polymer are both available. They are selected from different epoxy, polyimide, phenolic resin, silicone and others.

For inorganic adhesives, extraction method may also be used. The raw materials of adhesives should be water soluble. After hBN powders are mixed with inorganic water solution, an organic liquid, such as ethanol, is added into the solution. In this case, ethanol extracts water out, and makes adhesives deposit on the hBN surface. With this process, aluminum phosphate and sodium silicate (in a form of water glass) have already been successfully coated on hBN surface. For other inorganic materials, such as Al₂O₃—, CaO—, SiO₂—, B₂O₃—, P₂O₅— containing compounds, this method may also be used to make an even distributed coating.

In present tests, a phenolic epoxy (FM-15 from China) was used. PT110 (GE, Advanced Ceramics) hBN powder with a nominal size of 45 μm was used. A silane coupling agent (KH 550 from China) with 1.5 wt % was used. The epoxy coated hBN granules by extraction method are loaded in a mold for pressing process. The temperature of mold was 100° C. The curing temperature is 180° C.

### EXAMPLE 1

5 vol % (2.7 wt %) of epoxy was coated on the surface of 95 vol % of hBN powder with extraction method. The thermal conductivity along the base plan (X-Y plane) of the sheet is 73 W/m·K. The thermal conductivity along the Z direction is 7 W/m·K.

### EXAMPLE 2

10 vol % (5.5 wt %) of epoxy was coated on the 90 vol % of hBN powder with extraction method. Sample sizes are two inch and 6 inch discs with a thickness of 0.3 mm to 3 mm. The thermal conductivity is 48 W/m·K in the X-Y plane, and 7.5 W/m·K along the Z direction. The CTE along the X-Y plan is 3.5 ppm/K from RT to 150° C.

This description uses examples to disclose a new method to make a new heat spread sheet with high loading concentration of hBN powder. As an electric insulator, it has the best thermal conductivity in low CTE materials. It has also the lowest CTE in the thermal conducting materials. These properties of the hBN sheet can be further improved with larger hBN powder as raw material. From FIG. 3, it can be found that PT 110 hBN includes a lot of small powders of 10-20 μm. Smaller particle size has larger surface area, and needs more epoxy to make a coating on hBN surface, which results in a higher thermal resistance and higher CTE. If the particle size is increased to 80-100 μm, the thermal conductivity will be further increased, and CTE will be further decreased.

What is claimed is:

1. A heat spread sheet comprising hexagonal boron nitride powder, the hexagonal boron nitride powder is bonded by solid adhesives selected from organic adhesives and inorganic adhesives.

2. According to claim 1, the concentration of boron nitride in the sheet material is 70 to 98 vol %.

3. According to claim 1, the organic adhesives include thermoplastic and thermosetting polymers.

4. According to claim 1, the organic adhesives are selected from the group of epoxy, polyimide, phenolic resin, silicone, and others.

5. According to claim 1, the inorganic adhesives are selected from the group of Al₂O₃—, CaO—, SiO₂—, B₂O₃—, P₂O₅— containing compounds.

6. An extraction process to make a coating of adhesives on the surface of hexagonal boron nitride powders.

7. According to claim 6, water is used as extraction agent for organic solution.

8. According to claim 6, organic liquid is used as extraction agent for water solution.

9. A forming method of the boron nitride sheet, wherein pressing and rolling processes are used.
